(19) United States
(12) Patent Application Publication
(10) Pub. No.: US 2007/0051525 A1
(43) Pub. Date: Mar. 8, 2007

(54) Bay-filling member for electronic device

(75) Inventor: Jui-Lin Chen, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/367,816

(22) Filed: Mar. 3, 2006

(30) Foreign Application Priority Data
Sep. 7, 2005 (TW) 094215364

(51) Int. Cl. H02G 3/08

(52) U.S. Cl. 174/50

(57) ABSTRACT

The invention provides a bay-filling member for an electronic device employed to fill-in empty, currently unused bays of the electronic device in which such bay have at least first and second securing portions, wherein the bay-filling member has a casing, a third securing portion correspondingly coupled to the first securing portion, a fourth securing portion correspondingly coupled to the second securing portion, and elastic portions for being press-fit into the bay so as to allow the bay-filling member to adapt to the structure of free bays to simplify the structure of the bay-filling member, in order to address the shortcomings of conventional techniques.

### FIELD OF THE INVENTION

The present invention relates to a bay-filling member, and more particularly, to a bay-filling member for an electronic device.

### BACKGROUND OF THE INVENTION

Electronic devices need to meet varying requirements depending on the particular installation and such requirements may change over time. Thus, electronic devices such as computers or servers typically contain a number of expansion bays that can be used to increase functionality, enlarge capacity, or accommodate further upgrades in the future.

For example, a network server usually comprises a plurality of bays for hard disk drives, wherein each bay encloses a fixed storage space allowing a hard drive to be inserted for usage. Quite often, the actual needs of a particular installation do not require insertion of hard drives into all available bays. Any free bays will then be filled by a hard drive casing or the like, so as to avoid having openings in the free bays that could affect the heat dissipating airflow and adversely influence the operation of the server, and also to prevent external objects or contamination such as dust and debris from entering the server.

Normally, in the conventional filling technique, the size of a hard drive casing employed to fill the free bays and the size of the casing of an ordinary hard drive are the same. Thus, the original mounting tracks or rails of the server can be used for inserting the hard drive casing into the free bay. However, implementing this conventional technique requires fabricating an entire hard drive casing. Thus, not only is the structure more complicated but also the cost of production is higher.

In addition, implementing the conventional technique requires similar processes for assembling an ordinary hard drive during disassembly, only in reverse. Therefore, the process of disassembly is complicated and cannot be simplified, thereby making such implementation unfavorable. Further, as the hard drive casing employed in the conventional technique has the same size as an ordinary hard drive casing, the space required for storage after dissembly is therefore relatively larger.

A conventional computer 1, for example as shown in FIGS. 1A and 1B, comprises a panel 10 formed at the opening of a bay 12, wherein the panel 10 is a thin slice and the size thereof corresponds to the size of the opening of the bay 12. Inner-facing areas 102 near the vertical edges of the panel 10 comprise hook portions 103 respectively. During installation, the panel is aligned with the bay 12 and the hook portions 103 are pushed into corresponding positions of the bay 12, so that it can be fastened to the bay 12 to provide cover.

However, when the computer 1 needs a new hard disk drive to be installed therein, the panel 10 will then need to be disassembled from the bay 12. But as the hook portions 103 are located in the interior of the main case of the computer 1, the disassembling process is thus very inconvenient. If the panel 10 is forcibly pulled out from the edge of the panel 10, it will damage the panel 10 very easily and the panel 10 will not be re-useable, thereby wasting resources and potentially affecting the structure of the case of the computer 1. The conventional technique as such is not ideally suited to the intended usage.

Due to the drawbacks of the conventional technique having a complicated structure, higher cost of production, an inconvenient and labor-consuming disassembly process, requirement for a larger storage space when not in use, and, more notably, the potential to damage the structure of the main case, it is desirable to develop a bay-filling member for an electronic device so as to simplify the structure, reduce the cost of production, simplify the disassembly process, and to reduce storage space, while safe-guarding the internal structure of the main case.

### SUMMARY OF THE INVENTION

In light of the above prior-art drawbacks, a primary objective of the present invention is to provide a bay-filling member for an electronic device capable of simplifying the structure thereof.

Another objective of the present invention is to provide a bay-filling member for an electronic device that can effectively reduce the cost of production.

Still another objective of the present invention is to provide a bay-filling member for an electronic device that can simplify the disassembly process.

A further objective of the present invention is to provide a bay-filling member for an electronic device that can reduce storage space when not installed.

In accordance with the foregoing and other objectives, the present invention proposes a bay-filling member being filled into an electronic device having free bays in which the free bays have at least a first securing portion and a second securing portion, wherein the bay-filling member comprises at least a casing, a third securing portion, a fourth securing portion and elastic portions. The casing comprises a first side, a second side corresponding to the first side, a third side connecting to the first side and the second side, and a fourth side corresponding to the third side. The third securing portion is formed at the first side of the casing and correspondingly coupled to the first securing portion. The fourth securing portion is formed at the second side of the casing and correspondingly coupled to the second securing portion. The elastic portions are formed on at least one of the third side or the fourth side for being press-fit into the bay.

Preferably, the casing further comprises a panel, wherein the panel may be a plastic panel. Further, the panel may comprise an operating portion and a heat-dissipating portion, wherein the operating portion may be a finger hole and the heat-dissipating portion may be an opening. The third securing portion may be a protrusion. The fourth securing portion may be a protrusion as well. The elastic portions may have a plurality of resilient strips and may further form junctions so as to be press-fit into the bay and provide grounding at the same time.

Compared with the conventional bay-filling techniques, the bay-filling member in the present invention is designed to have the shorter length of a hard drive casing than the conventional one, so as to solve the complicated structural defects resulting from employing conventional casings for filling the free bays in the conventional techniques, and thus to correspondingly reduce the cost of production. Meanwhile, the third securing portion and the fourth securing portion are designed to correspond to the pre-formed securing structures of the bays, so that the elastic portions can be used to achieve the packing effect. The user only needs to use fingers, without any tool, to perform the disassembly process, thereby solving the problems of such an arduous and complicated disassembly process in the conventional process. In addition, as the length of the bay-filling member in the present invention is shorter, the defects of requiring larger storage spaces for the conventional hard disk drive after disassembly can thus be solved.

Accordingly, the present invention is capable of simplifying the structure of a bay-filling member of an electronic device, reducing the cost of production, simplifying the disassembling process, and minimizing the storage requirement, so as to solve the shortcomings of the conventional bay-filling technique.

### BRIEF DESCRIPTION OF THE DRAWINGS

The present invention can be more fully understood by reading the following detailed description of the preferred embodiments with reference made to the accompanying drawings, wherein:

FIG. 1A and 1B (PRIOR ART) are schematic views showing the conventional technique, wherein FIG. 1A is a schematic view showing the structure of a board and FIG. 1B is the exploded view showing a board of FIG. 1A assembled with an electronic device;

FIGS. 2A to 2D are schematic views showing the structure of a bay-filling member of the preferred embodiment according to the present invention, wherein FIG. 2A is the front view of the bay-filling member, FIG. 2B is the right side view of FIG. 2A, FIG. 2C is the left side view of FIG. 2A and FIG. 2D is the bottom view of FIG. 2A; and

FIGS. 3A and 3B are the three-dimensional views at different angles showing the structure of a bay-filling member of the preferred embodiments according to the present invention.

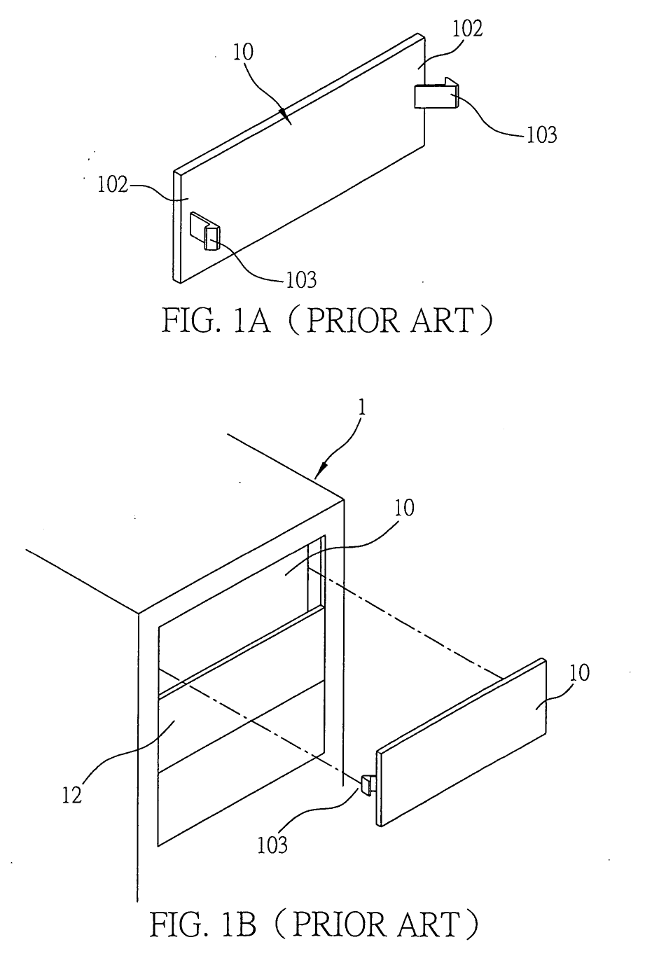

### DETAILED DESCRIPTION OF THE PREFERRED EMBODIMENTS

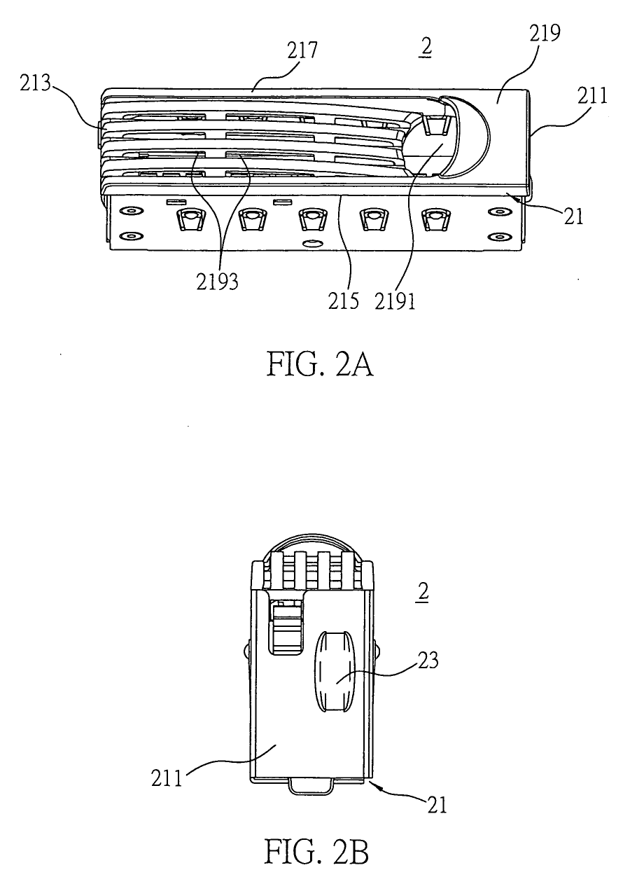

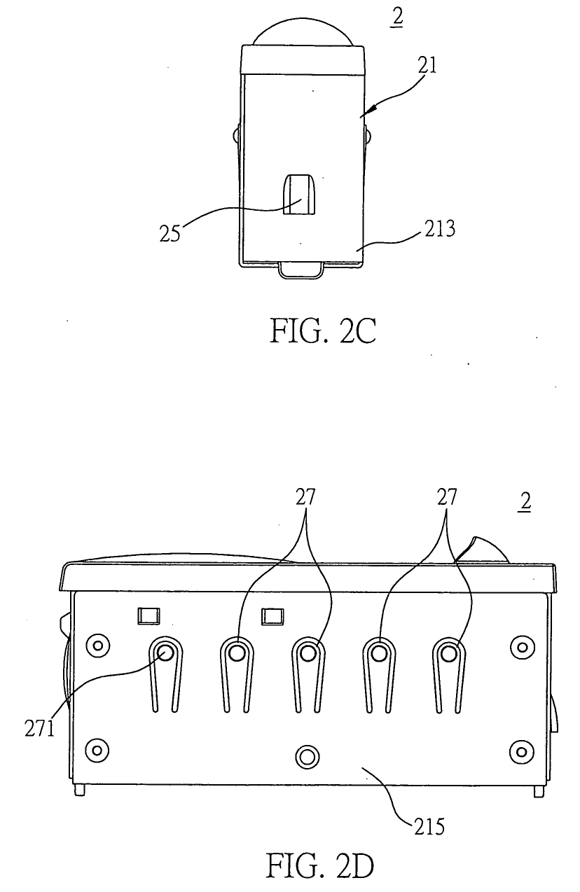

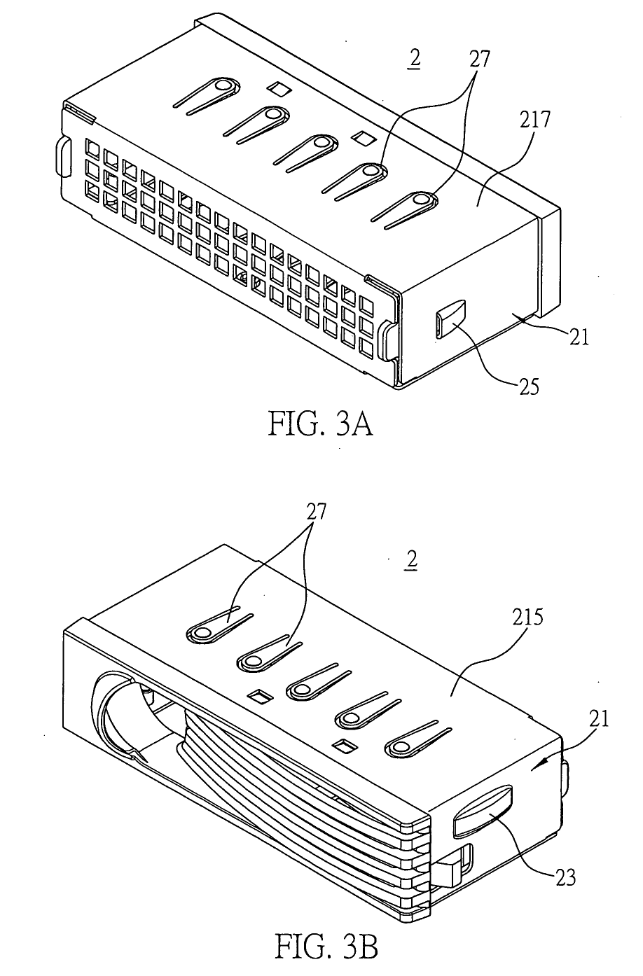

Preferred embodiments of a bay-filling member proposed in the present invention are described in detail as follows with reference to FIGS. 2A to 2D and FIGS. 3A to 3B. The present invention can be implemented or applied by other embodiments, and the details of the specification can also be reviewed and applied for modification and alternation without departing from the spirit of the present invention. It should be noted that in the preferred embodiments the bay-filling member is filled into an electronic device having free bays with at least a first securing portion and a second securing portion. Using a server as the electronic device having a bay openings not occupied with a hard disk drive as an example, both sides of the bay comprise a first securing portion such as a concave or a hole and a second securing portion such as a protrusion. Since such a structure is a common design for a server and the structures and the mechanism of a server and a hard disk drive are also well known, drawings for these are therefore not shown in the specification for the sake of simplicity and clarity of the characterized features and the structures of the present invention.

FIGS. 2A to 2D are perspective views of the structures of bay-filling member according to the present invention. The bay-filling member 2 comprises at least a casing 21, a third securing portion 23 correspondingly coupled to the first securing portion, a fourth securing portion 25 correspondingly coupled to the second securing portion, and elastic portions 27 that engage a side of the bay by pressure.

The casing 21 comprises a first side 211, a second side 213 corresponding to the first side 211, a third side 215 connecting to the first side 211 and the second side 213, and a fourth side 217 corresponding to the third side 215, wherein the size of the casing 21 is about the size of an ordinary hard disk drive but having a shorter length and being hollow so as to simplify the structure and to reduce the material used and the cost of production. As shown in FIG. 2A, the casing 21 may further comprise a panel 219, wherein the panel 219 may be a plastic panel or any other panel capable of being adapted to an ordinary hard disk drive exposed on the surface of a server. Further, the panel 219 may comprise an operating portion 2191 and a heat dissipating portion 2193. In this preferred embodiment, the operating portion 2191 may be a finger hole so that the user can insert a finger into the operating portion 2191 and pull out the casing 21 from that bay, whereas the heat-dissipating portion 2193 is equivalent to the heat-dissipating opening of the panel for an ordinary hard disk drive so as to maintain an equivalent way of heat dissipating when an ordinary hard disk drive is inserted.

As shown in FIG. 2B, the third securing portion 23 is formed on the first side 211 of the casing 21. In the preferred embodiment, the third securing portion 23 may be a protrusion corresponding to the first securing portion. The first securing portion such as a concave or a hole allows the bay-filling member 2 to be set in the bay while inserting thereinto so as to provide a securing effect; however, the bay-filling member 2 can still be pulled out readily with a bit of force if the bay-filling member 2 is to be removed from the bay. Moreover, it should be noted that the third securing portion 23 is designed to adapt to the structure of the first securing portion of a free bay. Therefore, if the first securing portion is modified into another design, the third securing portion 23 can be changed accordingly. For instance, when the first securing portion is a protrusion, the third portion 23 may be a concave or a hole, and is not limited to the aforementioned disclosure of the preferred embodiment.

As shown in FIG. 2C, the fourth securing portion 25 is formed on the second side 213 of the casing 21. In the preferred embodiment, the fourth securing portion 23 may be a protrusion corresponding to the second securing portion, and can be held or stopped by the second securing portion of the bay upon inserting the bay-filling member 2 into the bay. For example, as the second securing portion may be a protruded stopper and the size of the casing 21 is about the size of an ordinary hard disk drive with a relative shorter length thereof, by combining the fourth securing portion 25 with the second securing portion, the bay-filling member 2 undergoing insertion will therefore not be over-inserted in the bay; and further, the surface of the panel of bay-filling member 2 can be exposed from the bay and maintain approximate unity of appearance for the surface of various bays. Similarly, the fourth securing portion 25 is also designed to adapt to the structure of the second securing portion of a free bay. Therefore, if the second securing portion is modified to another design, the fourth securing portion 25 can be changed accordingly. As any person having ordinary skill in the art can do these kind of modifications, such variations are not further described.

As shown in FIG. 2D along with FIGS. 3A and 3B, the elastic portions 27 are formed on the third side 215 and the fourth side 217 of the casing 21, and may have a plurality of resilient strips. In the preferred embodiment, the elastic portions 27 may further form protruded parts such as junctions 217 so as to be pressure-fit into the bay and provide grounding at the same time. It is to be noted that in this preferred embodiment the elastic portions 27 are formed on the third side 215 and the fourth side 217 of the casing 21 respectively; however, in other embodiments the elastic portions 27 can be formed only either the third side 215 or the fourth side 217. Also, although the elastic portions 27 are placed equidistance from each other in this preferred embodiment, the location, quantity, and the arrangement of the elastic portion 27 can be modified in other embodiments. As any person having ordinary skill in the art can do these kinds of modifications, such modifications are not further illustrated.

Therefore, when the bay-filling member 2 is to be inserted into the bay, the casing 21 can be inserted as in the orientation shown in FIG. 3B until the third securing portion 23 correspondingly couples with the first securing portion and the fourth securing portion 25 correspondingly couples to the second securing portion, enabling the bay-filling member 2 to be quickly inserted and assembled into the bay. At the time, the elastic portions 27 can also provide useful frictional force so as to pressure-fit the bay-filling member 2 into the bay. Meanwhile, as the casing 21 is a hollow casing and has a heat dissipating portion 2193 equivalent to the heat dissipating hole on the panel of an ordinary hard disk drive, an equivalent way of heat dissipating can therefore be maintained when an ordinary hard disk drive is inserted; so as to avoid the openings of the free bays affecting the heat flow and heat dissipating and influencing the operation of the server, and also to prevent external objects such as dust and debris from entering the server machine.

Alternately, when the bay-filling member 2 is to be removed from the bay, it is only required to insert the finger(s) into the operating portion 2191 and pull out the bay-filling member using a low but sufficient force to overcome the frictional forces of the coupled members and the elastic members with the bay, thus providing a bay-filling member that is readily removable.

Compared with the conventional bay-filling techniques, the bay-filling member of the present invention is designed to have a shorter length casing than an ordinary hard disk drive and to adapt to the structure of the free bays, so as to simplify the structure and reduce the cost of production. Meanwhile, only the hand is required to perform the assembly/disassembly operations of the present invention of inserting or pulling out the bay-filling member, thereby simplifying the assembly and disassembly processes. In addition, as the length of the casing in the present invention is shorter than an ordinary hard disk drive, the storage space when not in use is thus correspondingly reduced.

Accordingly, the present invention can provide a structurally simplified bay-filling member adapted for the structure of a free bay, having effects such as reducing the cost of production and the storage space required, and being capable of assembly and disassembly without any tools, so as to solve the shortcomings of the conventional bay-filling technique.

The invention has been described using exemplary preferred embodiments. However, it is to be understood that the scope of the invention is not limited to the disclosed embodiments. On the contrary, it is intended to cover various modifications and similar arrangements. The scope of the claims therefore should be accorded the broadest interpretation so as to encompass all such modifications and similar arrangements.

What is claimed is:

1. A bay-filling member for an electronic device being filled into free bays in which the bays have at least a first securing portion and a second securing portion in the electronic device, comprising:
a casing having a first side, a second side corresponding to the first side, a third side connecting to the first side and the second side, and a fourth side corresponding to the third side;
a third securing portion formed at the first side of the casing and correspondingly coupled to the first securing portion;
a fourth securing portion formed at the second side of the casing and correspondingly coupled to the second securing portion; and
elastic portions formed on at least one of the third side or the fourth side for being press-fit into the bay.

2. The bay-filling member of claim 1, wherein the casing further comprises a panel.

3. The bay-filling member of claim 2, wherein the panel is a plastic panel.

4. The bay-filling member of claim 2, wherein the panel comprises an operating portion and a heat dissipating portion.

5. The bay-filling member of claim 4, wherein the heat dissipating portion is an opening.

6. The bay-filling member of claim 4, wherein operating portion is a finger hole.

7. The bay-filling member of claim 1, wherein the third securing portion is a protrusion.

8. The bay-filling member of claim 1, wherein the fourth securing portion is a protrusion.

9. The bay-filling member of claim 1, wherein the elastic portions comprise a plurality of resilient strips.

10. The bay-filling member of claim 1, wherein the elastic portions further comprise junctions.
